(19) United States
(12) Patent Application Publication
(10) Pub. No.: US 2014/0185236 A1
(43) Pub. Date: Jul. 3, 2014

(54) COOLING MODULE AND COMPUTER ENCLOSURE USING THE SAME

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: LEI LIU, Shenzhen (CN); GUO-YI CHEN, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/750,990

(22) Filed: Jan. 25, 2013

(30) Foreign Application Priority Data
Dec. 29, 2012 (CN) 201210588589.2

(51) Int. Cl. G06F 1/20; F28F 9/00

(52) U.S. Cl. CPC G06F 1/20; F28F 9/00
USPC 361/690; 165/185; 165/121

(57) ABSTRACT

A computer enclosure includes a rear wall and a cooling module. The rear wall defines a slot. The cooling module includes a bracket detachably attached to an outer surface of the rear wall and a heat dissipation member mounted to the bracket. The heat dissipation member draws air through the slot.

### BACKGROUND

1. Technical Field

The present disclosure relates to a cooling module and a computer enclosure including a cooling module.

2. Description of Related Art

A cooling system for computers usually includes a plurality of fans received in computer enclosures, to dissipate heat. Sometimes, the fans need to be repaired. Thus, a cover of a computer system needs be detached from the computer enclosure to take out the fans for repair, which is inconvenient.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, partial, cutaway, isometric view of a first exemplary embodiment of a computer enclosure, wherein the computer enclosure includes a chassis and a cooling module.

FIG. 2 is an enlarged view of the cooling module of FIG. 1, but viewed from another perspective.

FIG. 3 is an assembled, isometric view of the computer enclosure and cooling module of FIG. 1.

FIG. 4 is an exploded, partial, cutaway, isometric view of a second exemplary embodiment of a computer enclosure, wherein the computer enclosure includes a chassis and a cooling module.

FIG. 5 is an enlarged view of the cooling module of FIG. 4, but viewed from another perspective.

FIG. 6 is an assembled, isometric view of the computer enclosure and cooling module of FIG. 4.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

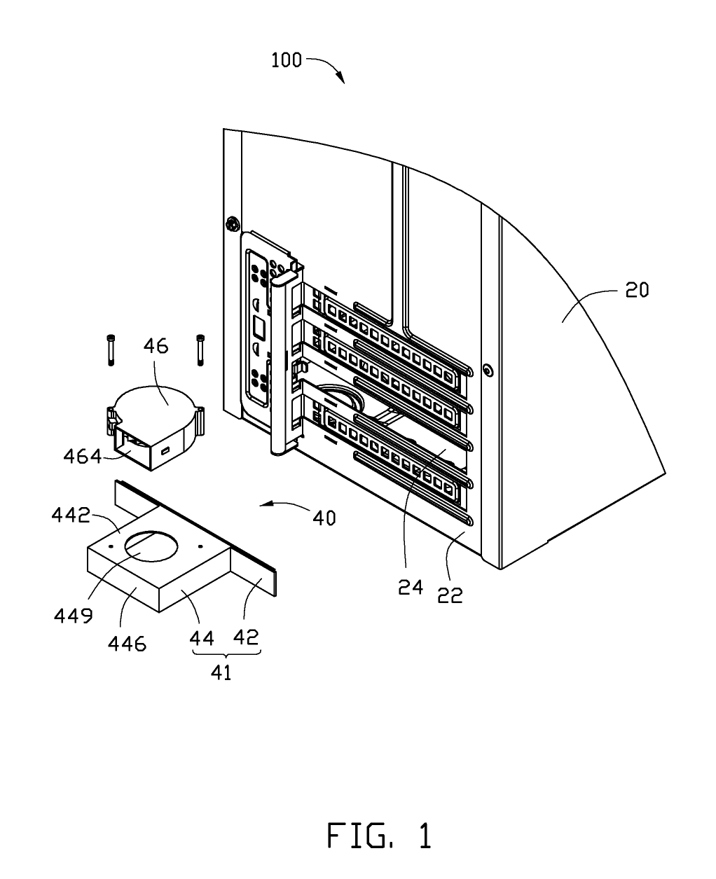

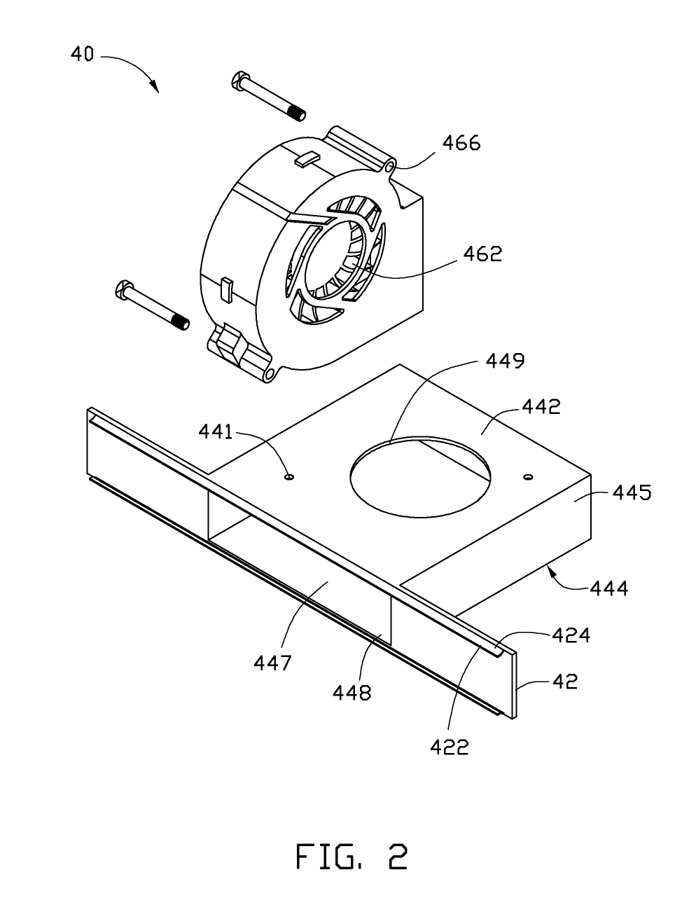

FIG. 1 and FIG. 2 show a first embodiment of a computer enclosure 100 including a chassis 20 and a cooling module 40.

The chassis 20 includes a rear wall 22 defining a plurality of spaced slots 24.

A plurality of electronic components (not shown), such as a motherboard, a plurality of expansion cards, and plurality of hard disk drives, are installed in the chassis 20. In the embodiment, the slots 24 are peripheral component interconnection slots.

The cooling module 40 includes a bracket 41 and a heat dissipation member 46 installed on the bracket 41. In the embodiment, the heat dissipation member 46 is a blower.

The bracket 41 includes a rectangular installing plate 42 and a shell 44. Two resilient latching bars 422 extend out from top and bottom sides of the installing plate 42, away from the shell 44. An outer surface of each latching bar 422 defines a latching slot 424 extending along a lengthwise direction of the installing plate 42. In the embodiment, the outer surface of the latching bar 422 is concaved to form a latching slot 424 having a substantially C-shaped cross-section. The shell 44 includes a top plate 442 perpendicularly extending out from the top side of the installing plate 42 away from the latching bar 422, a bottom plate 444 perpendicularly extending out from the bottom side of the installing plate 42 opposite to the top plate 442, two side plates 445 between the top plate 442 and the bottom plate 444, and an end plate 446 to complete the hollow box structure. The top plate 442, the bottom plate 444, the side plates 445, and the end plate 446 cooperatively bound an airflow channel 447. The installing plate 42 defines an opening 448 communicating with the airflow channel 447. The top plate 442 defines an air outlet 449 communicating with the airflow channel 447, and a plurality of screw holes 441 is located around the air outlet 449.

In the embodiment, the blower 46 defines an air inlet 462, an air outlet 464, and a plurality of through holes 466 located at the edges of the blower 46.

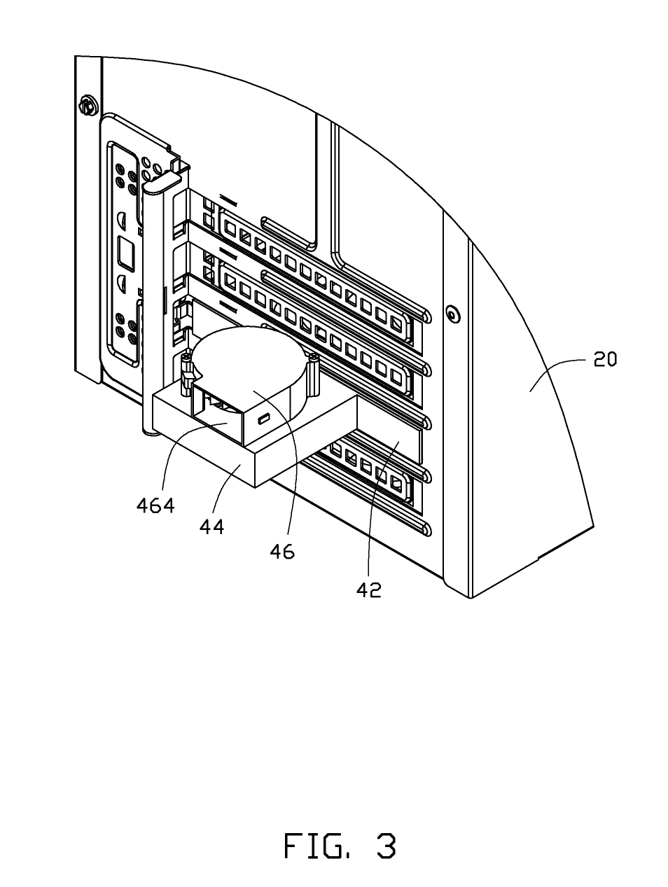

FIG. 3 shows that in assembly the blower 46 is supported on the top plate 442, the air inlet 462 of the blower 46 aligns with the air outlet 449 of the bracket 41, and the air outlet 464 of the blower 46 faces the same direction. A plurality of screws extends through the through holes 466, to be screwed into the screw holes 441 of the top plate 442. The latching bars 422 are pressed together and deformed to reduce the distance between them. The latching bars 422 are inserted into the slot 24 from an outer side of the chassis 20. The latching bars 422 are allowed to restore, enabling two opposite sidewalls bounding the slot 24 to latch into the latching slots 424.

In use, the blower 46 operates and draws airflow from the chassis 20. The airflow flows through the slot 24 of the chassis 20, the opening 448, the airflow channel 447, and the air outlet 449 of the bracket 41, enters the blower 46 through the air inlet 462 of the blower 46, and is exhausted out of the blower 46 through the air outlet 464 of the blower 46.

To detach the cooling module 40 from the chassis 20, the latching bars 422 are pressed together. The sidewalls bounding the slot 24 disengage from the latching slots 424. Thereby, and as simply as that, the cooling module 40 can be removed from the chassis 20.

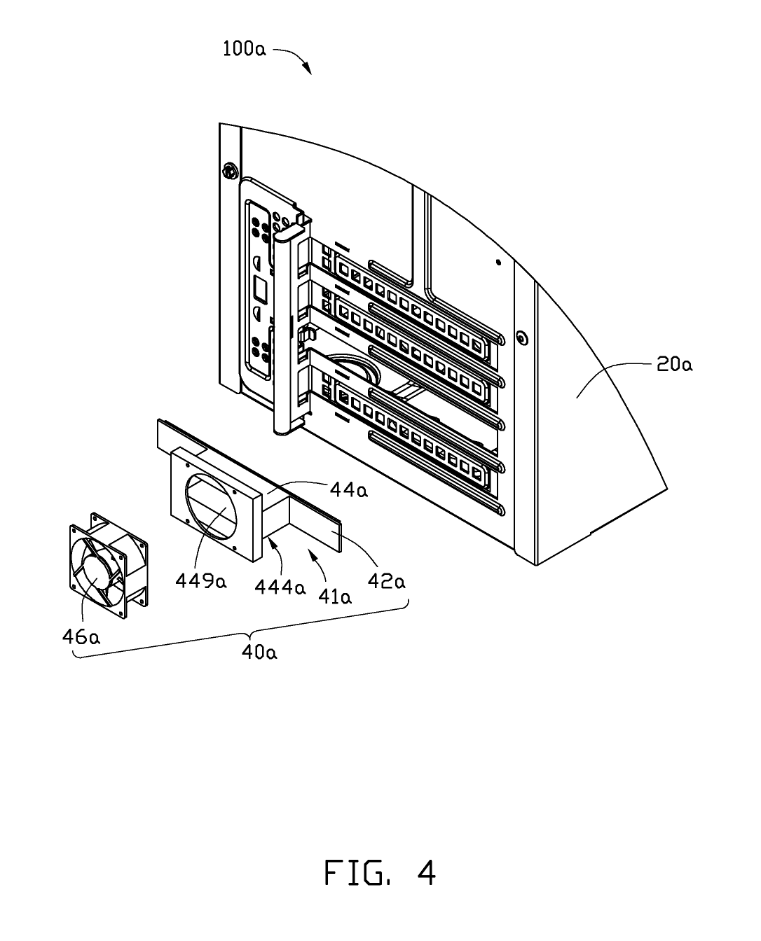

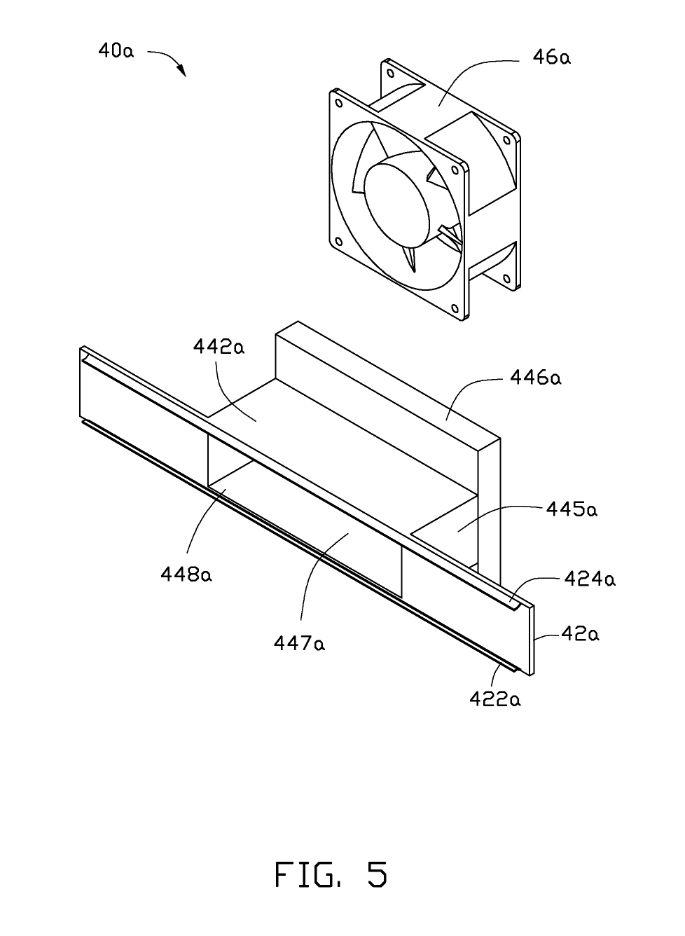

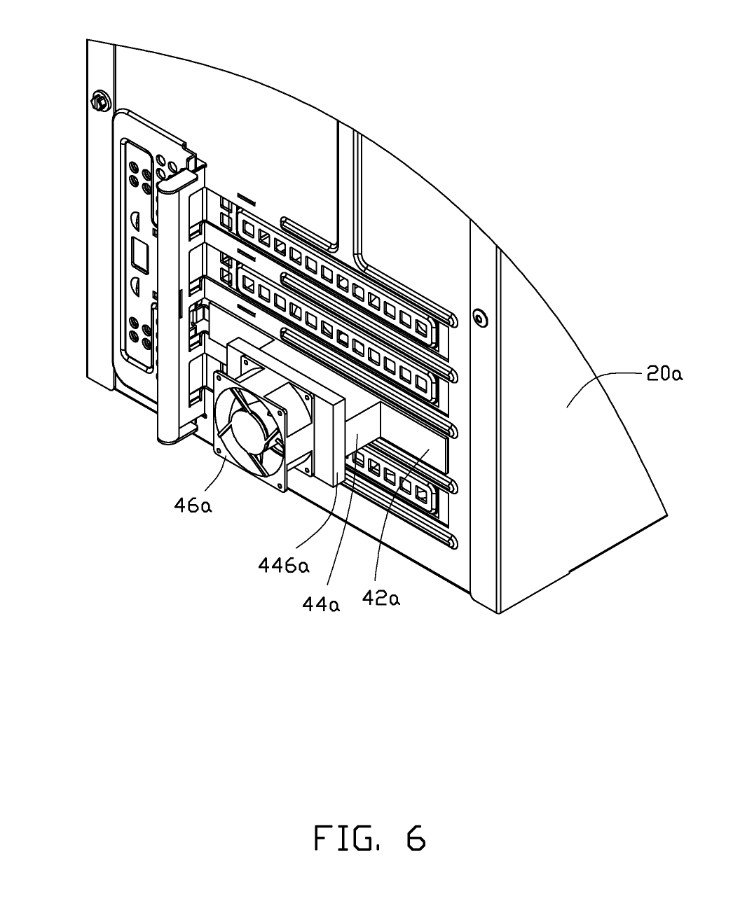

FIGS. 4-6 show a second embodiment of a computer enclosure 100a substantially similar to the first embodiment of the computer enclosure 100. The computer enclosure 100a includes a cooling module 40a. The cooling module 40a includes a bracket 41a and a heat dissipation member 46a. In the embodiment, the heat dissipation member 46a is a fan.

The bracket 41a includes a rectangular installing plate 42a and a substantially

T-shaped shell 44a. Two resilient latching bars 422a extend out from top and bottom sides of the installing plate 42a away from the shell 44a. An outer surface of each latching bar 422a defines a latching slot 424a extending lengthwise along the latching bar 422a. The shell 44a includes a top plate 442a, a bottom plate 444a, two side plates 445a, and an end plate 446a. The top plate 442a, the bottom plate 444a, the side plates 445a, and the end plate 446a cooperatively bound an airflow channel 447a. The installing plate 42a defines an opening 448a communicating with the airflow channel 447a. A middle of the end plate 446a defines an air outlet 449a communicating with the airflow channel 447a. In assembly, the fan 46a is mounted on the end plate 446a, to allow the fan 46a to align with the air outlet 449a. In use, the fan operates and draws air from the enclosure and exhausts the air through the air outlet 449a of the end plate 446a.

Even though numerous characteristics and advantages of the embodiments have been set forth in the foregoing description, together with details of the structure and function of the embodiments, the present disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. A cooling module, comprising:
a bracket comprising an installing plate and a shell protruding out from the installing plate, wherein the shell defines an air channel, the installing plate defines an opening communicating with the air channel, the shell defines a first air outlet communicating with the air channel; and
a heat dissipation member mounted to the bracket and defining a second air outlet aligning with the first air outlet of the shell.

2. The cooling module of claim 1, wherein two resilient latching bars extend out from two opposite sides of the installing plate away from the shell, an outer surface of each latching bar defines a latching slot extending along a lengthwise direction of the installing plate.

3. The cooling module of claim 2, wherein the latching slot has a substantially C-shaped cross-section, the outer surface of the latching bar is concaved to form the latching slot.

4. The cooling module of claim 1, wherein the shell comprises a top plate, a bottom plate opposite to the top plate, two side plates connected between sides of the top plate and the bottom plate, and an end plate to complete a hollow box structure, the bottom plate, and the side plates, the top plate, the bottom plate, the side plates, and the end plate cooperatively bound the air channel, the first air outlet is defined in the top plate, the heat dissipation member is a blower and mounted on the top plate of the shell.

5. The cooling module of claim 1, wherein the shell comprises a top plate, a bottom plate opposite to the top plate, two side plates, and an end plate, the top plate, the bottom plate, the side plates, and the end plate cooperatively bound the air channel, the air outlet is defined in the end plate, the heat dissipation member is a fan and mounted on the end plate of the shell.

6. A computer enclosure, comprising:
a rear wall defining a slot; and
a cooling module comprising a bracket and a heat dissipation member mounted to the bracket; wherein a bracket comprises an installing plate detachably attached to an outer surface of the rear wall and a shell protruding out from the installing plate, the shell defines an air channel, the installing plate defines an opening communicating with the air channel and the slot of the rear wall, the shell defines a first air outlet communicating with the air channel; the heat dissipation member defines a second air outlet aligning with the first air outlet of the shell.

7. The computer enclosure of claim 6, wherein the slot is a peripheral component interconnection slot.

8. The computer enclosure of claim 7, wherein two resilient latching bars extend out from two opposite sides of the installing plate, away from the shell, the latching bars are inserted into the slot, two opposite sidewalls bounding the slot are engaged with the latching bars.

9. The computer enclosure of claim 6, wherein the shell comprises a top plate, a bottom plate opposite to the top plate, two side plates connected between sides of the top plate and the bottom plate, and an end plate to complete a hollow box structure, the bottom plate, and the side plates, wherein the top plate, the bottom plate, the side plates, and the end plate cooperatively bound the air channel, the first air outlet is defined in the top plate, the heat dissipation member is a blower and mounted on the top plate of the shell.

10. The computer enclosure of claim 6, wherein the shell comprises a top plate, a bottom plate opposite to the top plate, two side plates, and an end plate, wherein the top plate, the bottom plate, the side plates, and the end plate cooperatively bound the air channel, the first air outlet is defined in the end plate, the heat dissipation member is a fan and mounted on the end plate of the shell.
